(19) United States
(12) Patent Application Publication
(10) Pub. No.: US 2008/0222041 A1
(43) Pub. Date: Sep. 11, 2008

(54) Methods and Systems for Electronic Agency in Performance of Services

(76) Inventor: Ganesh MANI, Pittsburgh, PA (US)

Correspondence Address: ECKERT SEAMANS CHERIN & MELLOTT, 600 GRANT STREET, 44TH FLOOR, PITTSBURGH, PA, 15219, US

(21) Appl. No.: 12/122,157

(22) Filed: May 16, 2008

Related U.S. Application Data
(63) Continuation of application No. 09/662,958, filed on Sep. 15, 2000, now abandoned.
(60) Provisional application No. 60/154,134, filed on Sep. 15, 1999.

(51) Int. Cl. G06Q 30/00; H04L 9/28

(52) U.S. Cl. 705/51; 705/80

(57) ABSTRACT

A computer implemented method for a principal to electronically establish and use an agent. The method comprising the steps of: the principal identifying a service requirement, the principal entering a communication medium to interact with a potential agent, the principal submitting an electronic request for service, the principal and the agent negotiating terms, establishing an electronic power of attorney between the principal and the agent, the agent performing the requested service; and the principal paying the agent.

### CROSS-REFERENCE TO RELATED APPLICATIONS

This application is a continuation of U.S. patent application Ser. No. 09/662,958, filed Sep. 15, 2000, and entitled “Methods and Systems for Electronic Agency in Performance of Services,” which claims the benefit of U.S. Provisional Patent Application Ser. No. 60/154,134, filed Sep. 15, 1999, and entitled “Methods and Systems for Electronic Agency in Performance of Services.”

### FIELD OF THE INVENTION

The present invention generally relates to methods and systems for transferring authority between and among principals and agents for performing services. The present invention more particularly relates to transferring legal authority by electronic means to enable agents to perform services which may normally require execution of a power of attorney document to transfer such authority. The present invention also relates to business processes for delegating performance of services to agents based on a principal's preferences and constraints as well as on agent feedback and rating systems.

### BACKGROUND INFORMATION

Modern timesaving products and processes seem to have increased discretionary or “free” time. However, instead of using this liberated time exclusively for leisurely pursuits, society has rushed to fill the discretionary void with additional activities including work-related pursuits. There exists in society a strong and sustained drive to perform more tasks and accomplish more goals using this newly available discretionary time.

An example of the impact of productivity improvement can be seen in the manufacturing sector. Traditional production practices generally embodied a vertically integrated, “cradle to grave” approach to building products. For example, all of the parts of a product such as a locomotive, including the nuts and screws, were produced and installed on the same site by the same company.

In contrast, a modern strategy has arisen and evolved which suggests that one's business activities should be focused on certain core competencies. It is generally believed that it is more economical to out-source those activities that are not considered part of one's core business. In other words, one should do what one does best and direct the remaining tasks to those who specialize in their performance and completion.

As another example, one's life can be separated into those activities that are core to one's career and those which are not part of the expert knowledge base of the individual. As a general principle, the time and resources spent learning how to perform a task outside of one's core activities should be balanced against the time and resources required in having someone else perform that task. It is a logical and reasonable conclusion that if the time and resources or “cost” of having the task performed by another are outweighed by the cost of self-performance, then the task should be out-sourced to an agent.

For example, a person who teaches elementary school may not have expertise related to a federal income tax issue. It is therefore desirable that the school teacher have a means to designate an agent, such as a tax preparation expert, to represent the school teacher in subsequent negotiations and discussions with the Internal Revenue Service regarding the particular tax issue. It will be appreciated that there is a general principle of economical distribution of resources which suggests that the school teacher should focus on her core competencies associated with teaching children, for example, and not spend valuable time and resources attaining the requisite level of expertise necessary to handle the tax issue.

However, a significant disadvantage to traditional review and selection of potential agents to assist in performing “non-core” services has been the amount of time necessary to locate suitable agents. The advent of electronic means such as the Internet has provided a convenient way for principals and agents to communicate and to negotiate the performance of these needed services.

What is needed therefore is a system and method for principals to interact with agents to locate a resource to perform a desired service. What is also needed is a relatively efficient and convenient authentication process that is preferably handled electronically to qualify the capacity of a particular agent. Furthermore, a system is needed wherein an agent having requisite credentials and capacity can undertake a multitude of tasks from databases containing information related to the principal. An object of the present invention is to have a variety of tasks performed and completed by an agent or agents while minimizing the time and resource spent on those tasks by the principal.

### SUMMARY OF THE INVENTION

These needs, and others, are met by the invention which provides a method for a principal to electronically locate and agent, give the agent a power of attorney, and pay the agent, and for an agent to perform a service requested by a principal.

It is an object of this invention to provide a computer implemented method for a principal to electronically establish and use an agent. The method includes the following steps: the principal identifying a service requirement, the principal submitting an electronic request for service, negotiating terms by principal and agent, establishing an electronic power of attorney, the agent performing said requested service, and, the principal paying said agent.

It is a further object of this invention to provide a computer readable medium containing instructions for performing a method for a principal to electronically establish and use an agent. The method includes the following steps: the principal identifying a service requirement, the principal submitting an electronic request for service, negotiating terms by principal and agent, establishing an electronic power of attorney, the agent performing said requested service, and, the principal paying said agent.

It is a further object of this invention to provide a computer system containing instructions for performing a method for a principal to electronically establish and use an agent. The method includes the following steps: the principal identifying a service requirement, the principal submitting an electronic request for service, negotiating terms by principal and agent, establishing an electronic power of attorney, the agent performing said requested service, and, the principal paying said agent.

It is a further object of this invention to provide a data transmission medium containing instructions for performing a method for a principal to electronically establish and use an agent. The method includes the following steps: the principal identifying a service requirement, the principal submitting an electronic request for service, negotiating terms by principal and agent, establishing an electronic power of attorney, the agent performing said requested service, and, the principal paying said agent.

### BRIEF DESCRIPTION OF THE FIGURE

FIG. 1 is a process flow diagram of a preferred method of the present invention.

### DETAILED DESCRIPTION

As used herein, the terms “principal” and “agent” are generally used to define the relationship between those who require services (“principals”) and those who perform the services (“agents”). The term “principal” can refer to a single individual or any other legal entity, such as a corporation, which can transfer authority to have tasks performed for it to an agent. The term “electronic” with reference to document storage and transfer has its usual meaning and also encompasses other media such as optical or magnetic media.

The invention includes identification of a need by the principal in step 102. A variety of needs can be identified by the principal that can be appropriately serviced by a competent agent. Among these needs are the following types or categories of services. This categorization of services is not intended to be an exhaustive listing of such services. It will be appreciated that other categories of services could be employed within the scope of the present invention. It will be further understood that the listing of particular services in each category is also not exhaustive and is provided for purposes of illustration. Other, unlisted services could be included within the scope and meaning of each category:

Real Estate

To buy, lease, sell, convey, mortgage, pledge or otherwise encumber or dispose of, and to contract with respect to, any property or interest. To engage in real property transactions, including the power to acquire, hold or dispose of real property (including the principal's residence) or any interest therein, including, but not limited to, the power to buy or sell at public or private sale for cash or credit or partly for each; exchange, mortgage, encumber, lease for any period of time; give or acquire options for sales, purchases, exchanges or leases; buy at judicial sale any property on which the principal holds a mortgage. In addition, the power to manage, repair, improve, maintain, restore, alter, build, protect or insure real property can be granted as well as to demolish structures or develop real estate or any interest in real estate.

The agent can be authorized to collect rent, sale proceeds and earnings from real estate, including mortgage payments; pay, contest, protest and compromise real estate taxes and assessments. The agent can also be empowered to grant easements; dedicate real estate; partition and subdivide real estate; and file plans, applications or other documents in connection therewith. The scope of the electronic power of attorney can include representation of the principal at a closing, specifically including the authority to sign any deed, assignment, other document of transfer, or closing statement on the principal's behalf. In general, the agent can be authorized to exercise all powers with respect to real property that the principal could if present.

Personal Property

An electronic power of attorney can include the capacity to engage in tangible personal property transactions, including the power to buy, sell, lease, exchange, collect, possess and take title to particular tangible personal property. The power of attorney could also include the authority to move, store, ship, restore, maintain, repair, improve, manage, preserve and insure the tangible personal property. In general, the agent can be given the power to perform all functions with respect to tangible personal property that the principal could if present.

Financial Concerns

The electronic power of attorney can include the capacity to transact all of the principal's business of any kind, including the receipt, payment or compromise of all accounts, bequests, investment or other income, debts and taxes which are due or payable to another or others; and, to execute all deeds, agreements, and such other instruments in writing.

The power of attorney can provide authority to the principal to engage in banking and financial transactions, including the power to sign checks, drafts, orders, notes, bills of exchange and other instruments or otherwise make withdrawals from checking, savings, transaction, deposit, loan or other accounts in the principal's name alone or with another or others, and endorse such items which are payable to the principal and receive the proceeds in cash or otherwise. The agent may also be able to open and close such accounts in the principal's name alone or with another or others, purchase and redeem savings certificates, certificates of deposit or similar instruments in the principal's name alone or with another or others, and execute and deliver receipts for any funds withdrawn or certificates redeemed.

The agent can also be empowered to deposit any funds received for the principal in the principal's accounts; do all acts regarding checking, savings, transaction, deposit, loan or other accounts, savings certificates, certificates of deposit or similar instruments; and, sign any tax information or reporting form required by federal, state or local taxing authorities. In general, if desired by the principal, the agent can be granted the power to transact any business with a banking or financial institution which, in the agent's determination, is deemed required.

Litigation Concerns

The electronic power of attorney can include the ability to pursue claims and litigation, including the power to institute, prosecute, defend, abandon, arbitrate, compromise, settle or otherwise dispose of, and appear for the principal in, any legal proceedings before any tribunal regarding any claim relating to the principal or to any property interest of the principal. Authority can also be transferred to collect and receive any claim or settlement proceeds; waive or release rights of such proceeds; and, employ and discharge attorneys as deemed necessary. In general, the agent can be authorized to exercise all powers with respect to claims and litigation.

Investment and Corporate Decisions

Authority can be given to an agent to engage in stock, bond and other securities transactions, including the power to buy or sell (including short sales) at public or private sale for cash or credit or partly for cash all types of stocks, bonds and securities; exchange, transfer, hypothecate, pledge or otherwise dispose of any stock, bond or other security; and, to collect dividends, interest and other distributions.

The agent can be given power to vote in person or by proxy, with or without power of substitution, either discretionary, general or otherwise, at any meeting with which the principal is associated. The agent may be empowered to join in any merger, reorganization, voting-trust plan or other concerted action of security holders, and make payments in connection therewith; to hold any evidence of the ownership of any stock, bond or other security belonging to the principal; to receive, hold or transfer securities in book-entry form; to invest and reinvest the principal's assets in such investments, including notes, mortgages, mutual funds, money market funds and cash management accounts and any investments not prohibited by law, to exercise stock options and for such purpose to borrow, pledging any of the principal's personal property as collateral therefor. In general, a power of attorney can grant capacity to the agent to exercise all powers with respect to the principal's stocks, bonds and securities.

General Business Decisions

The agent can be empowered to employ such agents, employees or representatives as appropriate, and to pay any fees, wages or other charges with respect to such employment; to borrow money on such terms and conditions as appropriate, and to pledge as collateral therefor any of the principal's assets; to take any actions on the principal's behalf with respect to any partnership, general or limited, or other business in which the principal has an interest; to create a trust for the principal's benefit, designating one or more persons as original or successor trustees, and to transfer to the trust any or all property owned by the principal; to add any or all of my property to any trust in existence when this power of attorney was created, provided that the terms of such trust relating to the disposition of income and corpus during my lifetime are the same as those set forth in the paragraph authorizing the creation of a trust for my benefit.

The power of attorney can grant the power to handle interests in estates and trusts, including the power to receive a bequest, devise, gift or other transfer of real or personal property to the principal in the principal's own right or as a fiduciary for another, and give full receipt and acquittance therefor or a refunding bond therefor; approve accounts of any estate, trust, partnership or other transaction in which the principal has an interest; and enter into any compromise and release in regard thereto.

Authority can be granted to renounce or resign any fiduciary position to which the principal has been appointed, and to terminate the principal's liability with respect to any position in such manner, formal or informal, as deemed appropriate. The agent can be authorized to withdraw the income or corpus of any trust over which the principal has power.

Health Care

The power of attorney can authorize the agent to admit the principal to any medical, nursing, residential or similar facility, to enter into agreements for the principal's care, and to authorize such medical and surgical procedures as deemed advisable.

Tax Concerns

The agent can be empowered to pursue tax matters on behalf of the principal, including the power to prepare, sign, verify and file any tax return including, but not limited to, joint returns and declarations of estimated tax; examine and copy of tax returns and tax records; sign an Internal Revenue Service power of attorney form; represent the principal before any taxing authority; protest and litigate tax assessments; claim, sue for and collect refunds of taxes, penalties and interest, and to receive, endorse and collect checks in payment of such refunds; waive rights and sign all documents required to settle, pay and determine tax liabilities; sign waivers extending the period of time for the assessment of taxes or tax deficiencies. In general, the agent can be empowered to exercise all powers with respect to tax matters.

Government Interaction

The principal can be authorized to receive government benefits, including the power to prepare, sign and file any claim or application for Social Security, unemployment, military service or other government benefits; collect and receipt for all government benefits or assistance; and, in general, exercise all powers with respect to government.

Insurance

The electronic power of attorney can grant power to engage in insurance transactions, including the power to purchase, continue, renew, convert or terminate any type of insurance (including, but not limited to, life, accident, health, disability or liability insurance); to pay premiums and collect benefits and proceeds under insurance policies; and to exercise non-forfeiture provisions under insurance policies. In general, the agent can be authorized to exercise all powers with respect to insurance in which the principal has any incidents of ownership.

Retirement Plans and Investments

The power of attorney document can grant power to engage in retirement plan transactions, including the power to contribute to, withdraw from and deposit funds in any type of retirement plan (including, but not limited to, any tax qualified or nonqualified pension, profit sharing, stock bonus, employee savings and retirement plan, deferred compensation plan or individual retirement account); select and change payment options for me; make rollover contributions from any retirement plan to other retirement plans; waive any right or benefit available to the principal under any retirement plan; and, in general, exercise all powers with respect to retirement plans.

Charitable Contributions

The principal can use electronic means to authorize the agent to make outright gifts of any property (including, but not limited to, real or personal, tangible or intangible property) in which the principal has an interest. In addition, the agent can be authorized to make charitable contributions of money or property to organizations, contributions to which are deductible for federal income tax purposes.

Personal Shopping and Purchases

The principal can authorize the agent to make purchases on behalf of the principal, including all manner of entertainment, travel and shopping-related purchases. This can include, for example, purchasing tickets to a sporting event or a movie or shopping for groceries. This authority could also include the agent arranging a vacation trip and resort lodging for the principal.

It will be understood that the preceding list is not intended to be an exhaustive listing of all potential tasks which could be undertaken by an agent. It will also be understood that any arrangement entered into between a principal and agent will be subject to and limited by federal, state and local laws.

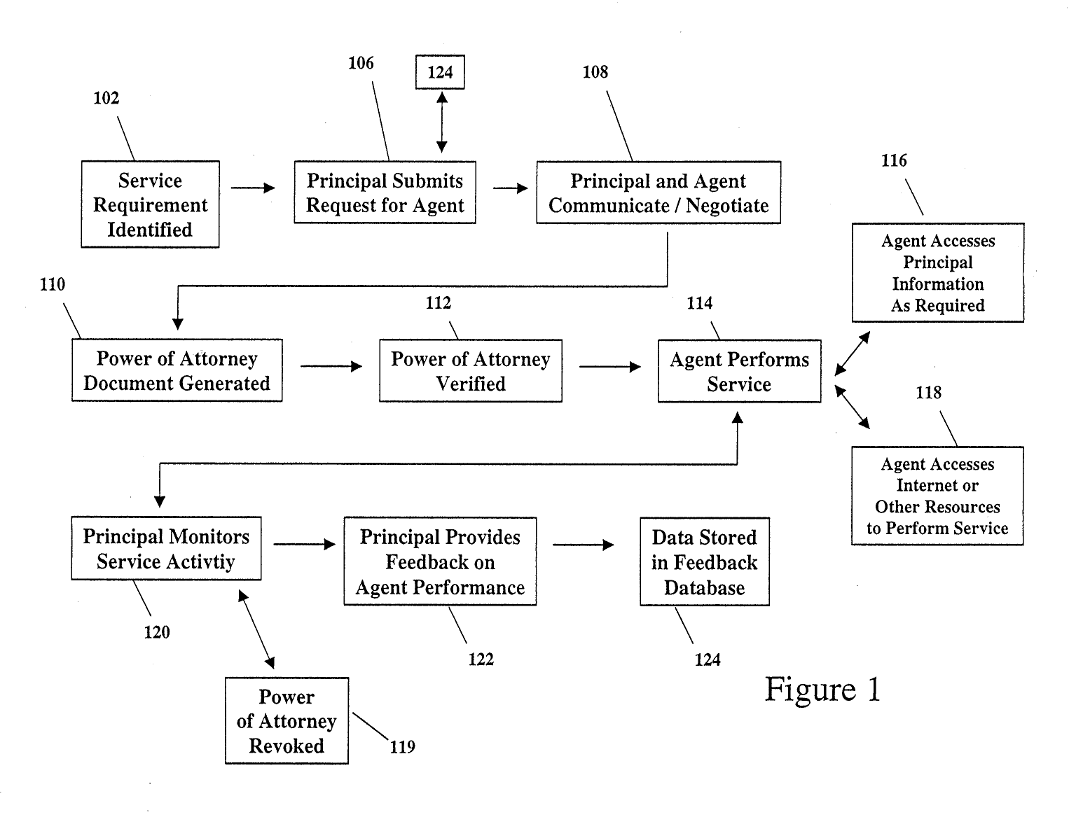

Referring again to FIG. 1, the principal enters into a communication medium to interact with a potential agent or agents. The communication medium is preferably embodied as a medium such as an Internet connection. In the communication medium, the principal has an information database that can be considered a portal site that contains pertinent information about the principal. This information may include, but is not limited to, a variety of confidential data such as the principal's name and address, social security number, savings and checking account balances, credit history, electronic income tax records, personal identification numbers providing access to investment accounts and the like. It will be understood that the communication could occur on any other suitable medium, such as two or more computer processing means connected together, which supports interaction between the principal and its portal site and/or an agent or agents.

The principal selects the service that it desires to be performed in step 106 along with a request for available agents to perform the desired service. The particular service, including the terms, conditions and other aspects of its performance, can be selected by the principal on the web site such as by use of conventional drop-down menus, option boxes, edit boxes and the like. The selection step 106 also interacts with the feedback or rating system 124 (discussed further herein) of the present invention to obtain available information on agents based on factors such as success with a particular kind of service, customer service, response time and the like.

A negotiation session is then instituted between the principal and the agent or agents in step 108. This negotiation session may be conducted as a real-time transaction, such as on-line between computers, or the principal may submit a request for a particular service and then wait for subsequent consideration of the request by one or more agents who are suited to perform the required service. It will be understood that negotiation of the service to be performed will include terms such as the scope of the service to be performed, the frequency of the service (i.e., one-time or on a periodic and repeated basis), the time when the service is to be performed and the like. In the negotiation phase 108, the principal can set “hard” or “soft” constraints which will direct the selected agent in his/her performance of the selected service. An example of a “soft” constraint might direct the agent to select an opera for the principal's viewing which plays on Mondays, Wednesdays and Saturdays during a given month. An example of a “hard” constraint might be a strict limit on the dollar amount, such as no more than $50 per ticket, to be spent on acquisition of the opera tickets by the agent.

In a preferred embodiment of the present invention, the agents are “expert ombudsmen” who serve similar problem-solving functions for multiple principals. Specialization of expert labor results in enhanced efficiency and is a significant benefit of the present invention. The expert agents can optionally be screened and rated, such as by an independent Internet service, based on factors such as quality of service performed obtained from data feedback from prior service recipients, for example.

It will be understood that the scope of the service performed may include anything along the spectrum from performing a specific, single task on a given day at a given time (such as a transfer of real property) up to the full ability of the agent to do all things which the principal could do for itself if present. In addition, the power of attorney may be non-transferable or the agent may grant one or more associate powers of attorney to other agents to assist in task completion.

Referring again to FIG. 1, once negotiations between principal and agent have been completed, the power of attorney document is generated in step 110. The form of the electronic power of attorney document can be any suitable form which clearly conveys the intent of the principal and agent to be bound by the terms and conditions placed on the performance of the particular service or services to be performed by the principal. It is preferred that the actual form of the power of attorney document be readily stored and retrieved by electrical, optic, magnetic or another similar conventional means.

Verification of the power of attorney document follows in step 112. The power of attorney document can be “signed” by a conventional means such as biometric fingerprint stamping or a digital signature. This “signature” verifies the intent of the principal to contract with the agent for a particular service or services. The “signature” also empowers the document for use by the agent in performing the desired service. A full discussion of digital signatures is provided in the Digital Signature Guidelines Tutorial provided by the American Bar Association Section of Science and Technology Information Security Committee.

A system known for implementing digital signatures is an asymmetric cryptosystem: A system which generates and employs a secure key pair, which includes a private key for creating a digital signature and a public key to verify a digital signature. This system can be used to create, for example, a power of attorney certificate by creating a digital signature corresponding to the agent and a digital signature corresponding to the principal. Another digital signature corresponding to the agent is employed to permit the agent to perform and complete services with third-party individuals and organizations.

Biometric methods can be used in addition to the private-public key system for verification of an agent's capacity. The biometric (including finger, hand, retinal or other analogous imprint) or symbolic signature of the principal is suitably digitized along with a similar signature of the agent. In addition, the present invention permits the agent either to receive the principal's passwords verbatim or to obtain a “master key” type password which, when presented to those involved with performance of the selected service, allows the agent access to the required accounts of the principal.

Referring again to FIG. 1, the agent performs the service, subject to the principal's predetermined terms and conditions, in step 114 and generates progress reports on its activity either through on-line, computer, facsimile, or other means. It can be understood that third parties have suitable means for verifying the power of attorney document and to ensure that it has not been altered. In addition, means are available for verifying the agent's signature and matching it with the signature in the power of attorney document. During performance of the selected service or services, the agent will interact with the principal's information database as shown in step 116. As previously discussed herein, the degree of access authorized for the agent depends on the nature and scope of the selected service. Resolution of a tax issue by the agent, for example, does not require that agent's review of the principal's medical records, for example.

The agent accesses Internet pages (containing principal-specific information and links) to perform the required tasks as shown in step 118. Some of the tasks can be performed using generic Internet pages, the telephone or another conventional method. An alert mechanism can also be provided to alert the user when transactions occur outside of predetermined terms and conditions. For example, the agent can be limited to expenditures of a certain dollar amount, such as $500, for example. An alert mechanism can be triggered if the agent spends, for example, $1,000 on a transaction. The transaction can be prohibited from completion based on the established limitations. In addition, the expenditure of $5,000, for example, or another attempted illegal action by the agent, can result in automatic revocation of the power of attorney as shown in step 119. A significant benefit of this feature is to resist fraud by an unscrupulous agent.

The principal can monitor the principal's performance by a suitable means in step 120. Likewise, the principal has the option of providing feedback on the agent's performance in step 122. A conventional means such as an activity log can be provided for keeping track of items such as what tasks are conducted, who was dealt with, time stamps and the like. The purpose of such monitoring is to provide a “work in progress” or transaction history type of report on the agent's activities. The monitoring function can provide a time-stamped database of transactions and information updates that serves as feedback to the principal. If desired by the principal, the monitoring function also provides for transmitting an e-mail or other electronic message to the agent, in the event that a question, comment or change in orders arises during the agent” performance. It can be understood that a suitable activity log could be modeled based on conventional tracking software such as that software employed by package shippers, for example, to identify location and delivery of a given package or packages.

The system and method of the present invention also permit a principal to revoke the electronic power of attorney at any point along the process flow. A means can be provided for revoking the power of attorney, based on variety of automatic triggers, such as those previously discussed, or just based on the principal deciding to do so. This power to revoke authority or otherwise adjust instructions for the agent in executing the selected service is shown more particularly in step 119 of FIG. 1.

In step 124, the rating of the agent by the principal is stored in a conventional database. It can be appreciated that the principal will have a personal history of feedback on agents it has used and the ratings it has given each agent. If, for example, each agent is given an arbitrary alphanumeric identifier, then the principal can correlate this identifier to a rating by type of service performed based on promptness, effectiveness, price, quality, principal satisfaction and the like. The principal's personal feedback history also has a suitable mechanism, such as an edit field, in which the principal can make notes and other observations based on the agent's performance. This personal observation mechanism serves as a reminder to the principal to focus on or to avoid certain agents in future negotiations. Likewise the rating feedback received from a multitude of principals can be employed to establish a “historical” rating for each agent based on similar rating factors. All of this information can be made available to principals based on their usage and participation with a particular web site service provider.

At some point in the method and system of the present invention, the principal pays the agent for services rendered. A number of possible scenarios can be provided for compensating the agent.

The principal can buy a fixed quantity of agent hours from the web site provider, such as a quantity of 100 hours. The principal and agent negotiate about the amount of time that will be required to complete the selected service. The agent can suggest a maximum number of hours to the principal in which to perform the desired service. Once the service is performed, the system multiples the actual number of hours required for this service by the agent's applicable hourly rate. It can be understood that the agent's rate depends on factors such as experience, type of service performed, the historical rating of the agent and the like.

Other arrangements can be made for agent compensation including a fixed-fee arrangement for certain standard activities. For example, hiring an agent to make a charitable donation and obtain a receipt can be a basic $10 charge as a standard service. In addition, it can be appreciated that more complex services require greater communication between principal and agent as to how and when compensation is to be provided.

The web site provider can establish incentive plans that pay a greater percentage of profits to those agents who have better ratings compared to other agents. Those agents with comparatively better ratings may also command a higher rate for a particular service. A suitable bonus system can also be established based on excellence in agent performance of individual services as well as historical ratings over time.

It will be appreciated that safeguards can be instituted in the method and system of the present invention to decrease the probability of fraudulent transactions. In a preferred embodiment of the present invention, a bonding and insurance means is provided for agents. This permits principals and third parties to recover damages from unauthorized or unsatisfactory agent transactions. It will be appreciated that transactions may have liability limitations associated with them which are delineated in the contract between principal and agent.

### EXAMPLES

The examples contained herein are intended to illustrate certain aspects of the practice of the present invention. These examples are therefore not intended to limit the scope of the present invention.

### Example 1

### Operational Overview of a System Embodiment

Login Screens

The principal accesses his/her database information by entering a suitable communication medium such as by establishing an Internet connection with a service provider who offers an environment for principal and agent negotiations:

```
Principal:
        Name:
        Password:
```

A relatively long password can be automatically inserted into the “Password” field if a conventional biometric device is used in conjunction with the computer or other suitable processor that the principal is using to communicate his/her service requirements.

Likewise the agents have a location, such as location on an Internet site, wherein they can access available requests for services to be performed on behalf of principals:

```
Agent:
        Name:
        Password:
```

### Principal Activities

Principals are then transferred to a screen with the following choices that can be selected such as by clicking on option buttons with a mouse, for example:

Tasks

Monitor Current Tasks (this function can include a link to permit a principal to rate the agent on a task after the task's completion or after the services of the agent have been otherwise terminated)

### Create New Task

Desired Agent: (if none is specified, an agent will be chosen based on the task and the best available ratings of agents for that kind of task)

Task Description:

Hard Constraints:

Soft Constraints:
Miscellaneous Data Entry Field: (including information such as how often to update task status, whether input from Principal is required while the task is being performed, and any other text input information which is required to perform the desired task and which cannot be communicated to the potential agent merely by selecting, for example, an option button)
Links to Task Resources (if, for instance, it is a shopping task, links to “amazon.com,” “buy.com” and the like are made available; this field can be initially completed or defaulted by the system automatically with references to databases providing the option to the principal to edit the default information)
Link to Relevant Principal—Principal Portal Site or Information Database (once any negotiation/communication with the agent is completed and the electronic power of attorney is established, one of the consequences of the successful negotiation is to enable this link)

Archived Tasks

All of the historical information about tasks previously requested by the principal and completed by a particular agent or agents are listed in this screen. Information on these tasks includes all relevant data including data such as time and date task completed, cost for completion, rating or ratings assigned to the agent or agents by the principal and the like.

Principal Portal Site Information

Financial Information

Bank and Brokerage Accounts

Credit Cards

Mortgages

Loans

Bills

. . . . . . .

(The above information can include only the data stored in the primary “Principal Portal Site” or can include links to other sites where auxiliary data is stored. For example, clicking on “Bills” can lead to sites such as “paymybills.com” where the information regarding Principal's bills is stored and can be accessed by the agent. It is understood that there can be “local” information which is maintained on the environment where principal and agent negotiations occur, and there can be “auxiliary” information which is drawn from a location other than the principal/agent communication medium, such as a link to the principal's bank, for example.)

Medical Information

Physicians (Clicking on this reveals the list of current Physicians for the Principal)

Hospitals

Pharmacies (This can include links to sites such as “personalmd.com” where Principal's medical records are stored and can be retrieved by an authorized agent)

. . . . . . ..

Tangible Assets

. . . . . . ..

Family

Spouse

Children

Parents

. . . . . . ..

(It will be appreciated that a functionality such as an “Edit” button is available to change existing information listed above as well as to add new information into existing categories or add new categories, such as a Passwords category which provides all accounts held by the Principal whether electronic, optical, magnetic or other conventional account.)

### Agent Activities

(After “logging in” to the system, agents are taken to screens, some of which include the following categories:)

To-be-Completed Tasks

(This screen includes a listing of currently negotiated tasks, a description or descriptions can be provided for each task including the following information:)

Principal's Name:

Task Description:

Hard Constraints:

Soft Constraints:

Other instructions (such as how often to update task status, whether input from Principal is required while the task is being performed, and the like, which is defined by the principals specified and agreed upon requirements)

Task progress (this will be updated periodically by agent and an automatic time stamp will be generated)

Links to Task Resources (if, for instance, it is a shopping task, links to “amazon.com,” “buy.com” and the like; this field can be initially completed or defaulted by the system automatically with references to databases providing the option to the principal to edit the default information)

Link to Relevant Principal—Principal Portal Site or Information Database

(once any negotiation/communication with the agent is completed and the electronic power of attorney is established, one of the consequences of the successful negotiation is to enable this link)

(Functionality is also conventionally provided to sort and organize tasks by suggested task resources which enable the agent to complete multiple tasks with the same provider for different principals. Examples of this activity include a) calling the same phone company to resolve different phone calls for multiple principals; and b) online gift purchases from the same vendor for multiple principals and their recipients. In this particular example, the principals can favorably benefit from the “volume” discount obtained by virtue of the agent's multiple representation.

### Example 2

### Purchase of Movie Tickets by an Agent Acting Under an Electronic Power of Attorney

From his home on Monday, a principal establishes an Internet connection with his computer with the service provider providing access to the domain name “epowerofattorney.com.” The principal accesses his personal information and verifies his checking account balance by making several option button clicks with his mouse and then clicking on a link to his portal site. He updates the current account balance and then links to a credit card information screen to select his preferred credit card that is to be used first for any future purchases. He selects an additional option button which authorizes agents in his employment who have access to this information screen to use a secondary or tertiary selected credit card in the event that the limit on the preferred or primary credit card has been exceeded.

The principal then links to another information input screen entitled “Create New Task” with the intention of sending out a request for acquisition of a pair of movie tickets. The principal enters the following information:

Hard Constraint—cost of movie tickets cannot exceed $20.

Soft Constraint—a matinee showing before 6:00 p.m. is preferred unless unavailable; any weekday for seeing the movie is acceptable to the principal.

Desired Agent—none is specified, the principal wants the best-rated agent who is available and ready to pursue a set of movie tickets for the principal subject to the above-identified constraints.

Miscellaneous Data Entry Field—the principal indicates that he will not require a status report until the task is completed; the principal also indicates that the name of the movie he would like to see is “Firestorm”.

Links to Task Resources—the “movie” category is recognized by the system and the system lists several popular sites related to movies, theaters and movie reviews.

Link to Relevant Principal—Principal Portal Site or Information Database—Hypertext pointing to the principal's personal information is highlighted; the principal has defaulted access for any agent making a movie ticket purchase for the principal to have access to the principal's credit card information; the principal's information is also used to locate a movie theatre which is a reasonable distance from the principal's home.

The principal submits the service request and within a few minutes the third-best rated agent for obtaining movie tickets contacts the principal by sending a message to the principal's activity log including the cost of the service to be completed. The principal accepts the agent by clicking an “Accept Agent” button that generates a digital signature corresponding to an electronic power of attorney document that is then generated. This electronic power of attorney also includes the digital signatures of both the principal and the agent and is assigned an alphanumeric reference number.

The agent then accesses a movie related Internet site on his computer and locates a pair of tickets satisfying all the constraints of the principal. The agent accesses the principal's credit card information by using the electronic power of attorney on the “epowerofattorney.com” Internet site to access the principal's portal site. The agent then reports his progress by updating the principal's activity log and referencing the electronic power of attorney reference number.

The principal conducts other business for several hours and then returns to the “epoa.com” site to check his activity log. The activity log indicates that a purchase in the amount of $15.75 including applicable taxes was applied to his primary credit card in satisfaction of the terms and conditions of the electronic power of attorney having the assigned reference number. The tickets are for a showing of “Firestorm” on Wednesday at 4:00 p.m. The activity log indicates that the tickets will be made available for pick up by the principal at the theatre before the showing.

The principal is extremely satisfied with the performance of this agent, since the last agent the principal used did not indicate in his progress report how the tickets would be sent to the principal. The principal gives this agent a 4 out of 5 rating in three rating criteria and a 5 out of 5 on four other rating criteria. This information is recorded by agent reference number into the principal's personal rating system and is also copied into the master rating database to generate a continuous, historical average of the agent's performance with regard to obtaining movie tickets. The principal's on-line account of agent hours is debited for 0.5 hours, which represents the amount of time the agent spent obtaining the movie tickets. The agent's own salary account is credited for this 0.5 hour transaction and multiplied by the agent's current rate for performing this type of service.

Whereas particular embodiments of this invention have been described above for purposes of illustration, it will be evident to those skilled in the art that numerous variations of the details of the present invention may be made without departing from the scope of the invention.

What is claimed is:

1. A computer implemented method for a principal to electronically establish and use an agent, said method comprising the steps of:
(a) said principal identifying a service requirement;
(b) said principal entering a communication medium to interact with a potential agent;
(c) said principal submitting an electronic request for service;
(d) negotiating terms by principal and agent;
(e) establishing an electronic power of attorney by generating a digital power of attorney document and electronically signing said power of attorney document;
(f) said agent performing said requested service; and
(g) said principal paying said agent.

2. The method of claim 1, wherein said step of submitting a request for service includes the steps of:
(a) identifying the service requested;
(b) providing a database having information relating to available agents; and
(c) connecting an agent able to perform said requested service with said principal.

3. The method of claim 2, wherein said submitting a request for service further includes the steps of:
(a) said principal identifying terms and conditions relating to the performance of said requested service; and
(b) transmitting said terms and conditions to available agents.

4. The method of claim 3, wherein said negotiating step includes the steps of:
(a) establishing constraints on the performance of said agent.

5. The method of claim 1, wherein said step of establishing an electronic power of attorney further includes the steps of:
(a) electronically verifying said electronic signature; and
(b) providing an electronic key that allows said agent to access selected information about said principal electronically.

6. The method of claim 5, wherein said electronic verification is performed by an asymmetric cryptosystem.

7. The method of claim 5, wherein said electronic verification is performed by a biometric method.

8. The method of claim 5, wherein said selected information about said principal is stored in an information database and said step of agent performing said requested service includes the steps of:
(a) said agent accessing said principal information database;
(b) said agent interacting with third parties to perform said requested service; and
(c) said agent reporting completion of said requested service to said principal.

9. The method of claim 8, wherein said third parties can electronically verify the status of said agent.

10. The method of claim 8, wherein said step of performing said requested service includes the steps of:
(a) said agent updating said information database with a status report; and
(b) said principal accessing said information database.

11. The method of claim 8, wherein said step of performing said requested service includes the steps of:
(a) said agent generating a status report; and
(b) said agent delivering said report to said principal.

12. The method of claim 8, wherein said step of performing said service includes the step of:
(a) said principal terminating said power of attorney.

13. The method of claim 8, wherein said step of performing said service includes the step of:
(a) said principal providing a rating of said agent.

14. A computer readable medium containing instructions for performing a method for a principal to electronically establish and use an agent, said method comprising the steps of:
(a) said principal identifying a service requirement;
(b) said principal entering a communication medium to interact with a potential agent;
(c) said principal submitting an electronic request for service;
(d) negotiating terms by principal and agent;
(e) establishing an electronic power of attorney by generating a digital power of attorney document and electronically signing said power of attorney document;
(f) said agent performing said requested service; and
(g) said principal paying said agent.

15. The computer readable medium of claim 14, wherein said step of submitting a request for service includes the steps of:
(a) identifying the service requested;
(b) providing a database having information relating to available agents; and
(c) connecting an agent able to perform said requested service with said principal.

16. The computer readable medium of claim 15, wherein said submitting a request for service further includes the steps of:
(a) said principal identifying terms and conditions relating to the performance of said requested service; and
(b) transmitting said terms and conditions to available agents.

17. The computer readable medium of claim 16, wherein said negotiating step includes the steps of:
(a) establishing constraints on the performance of said agent.

18. The computer readable medium of claim 14, wherein said step of establishing an electronic power of attorney further includes the steps of:
(a) electronically verifying said electronic signature; and
(b) providing an electronic key that allows said agent to access selected information about said principal electronically.

19. The computer readable medium of claim 18, wherein said electronic verification is performed by an asymmetric cryptosystem.

20. The computer readable medium of claim 18, wherein said electronic verification is performed by a biometric method.

21. The computer readable medium of claim 14, wherein said selected information about said principal is stored in an information database and said step of agent performing said requested service includes the steps of:
(a) said agent accessing said principal information database;
(b) said agent interacting with third parties to perform said requested service; and
(c) said agent reporting completion of said requested service to said principal.

22. The computer readable medium of claim 21, wherein said third parties can electronically verify the status of said agent.

23. The computer readable medium of claim 21, wherein said step of performing said requested service includes the steps of:
(a) said agent updating said information database with a status report; and
(b) said principal accessing said information database.

24. The computer readable medium of claim 21, wherein said step of performing said requested service includes the steps of:
(a) said agent generating a status report; and
(b) said agent delivering said report to said principal.

25. The computer readable medium of claim 21, wherein said step of performing said service includes the step of:
(a) said principal terminating said power of attorney.

26. The computer readable medium of claim 21, wherein said step of performing said service includes the step of:
(a) terminating said power of attorney upon said agent violating said terms and conditions or said constraints.

27. The computer readable medium of claim 21, wherein said step of performing said service includes the step of:
(a) said principal providing a rating of said agent.
